(19) United States
(12) Patent Application Publication
(10) Pub. No.: US 2022/0103886 A1
(43) Pub. Date: Mar. 31, 2022

(54) SYSTEMS, METHODS, AND MEDIA FOR PROVIDING AN ENHANCED REMOTE CONTROL

(71) Applicant: Google LLC, Mountain View, CA (US)

(72) Inventors: Ashwin Kumar Srigiri, Bengaluru (IN); Sandeep Khunteta, Bengaluru (IN)

(21) Appl. No.: 17/034,209

(22) Filed: Sep. 28, 2020

(51) Int. Cl. H04N 21/422; H04N 21/4415

(52) U.S. Cl. CPC H04N 21/42206; G06K 9/00087; H04N 21/4415

(57) ABSTRACT

Systems, methods, and media for providing an enhanced remote control are provided. In some implementations, a method for using enhanced remote controls is provided, the method comprising: detecting, at a remote control, a fingerprint of a user using a fingerprint sensor on the remote control; identifying the user from a plurality of users based on the fingerprint; authenticating, without user input, a user account corresponding to the identified user, wherein the user account is associated with a media content service that hosts and provides media content items to a media device paired with the remote control; causing a plurality of indications of available media content items to be presented on the media device based on the authenticated user account; receiving a selection of an indication of an available media content item via the remote control; causing the selected media content item to begin being presented on the media device paired with the remote control; and causing content related to the media content item to be presented on a display area of the remote control concurrently with presentation of the media content item on the media device.

### TECHNICAL FIELD

The disclosed subject matter relates to systems, methods, and media for providing an enhanced remote control.

### BACKGROUND

Users frequently watch different types of video content on televisions, such as streamed content, broadcast content, user-generated content, etc. However, it can be difficult to navigate through different types of content. Additionally, different users may access different user accounts on the same television. For example, there may be multiple users within one household who each have different accounts with a particular video content service. Continuing with this example, the video content service may provide personalized recommendations for each user account. However, it can be difficult to switch user accounts in connection with different video content services.

Accordingly, it is desirable to provide systems, methods, and media for providing an enhanced remote control.

### SUMMARY

In accordance with various implementations of the disclosed subject matter, systems, methods, and media for providing an enhanced remote control are provided.

In accordance with some implementations of the disclosed subject matter, a method for using enhanced remote controls is provided, the method comprising: detecting, at a remote control, a fingerprint of a user using a fingerprint sensor on the remote control; identifying the user from a plurality of users based on the fingerprint; authenticating, without user input, a user account corresponding to the identified user, wherein the user account is associated with a media content service that hosts and provides media content items to a media device paired with the remote control; causing a plurality of indications of available media content items to be presented on the media device based on the authenticated user account; receiving a selection of an indication of an available media content item via the remote control; causing the selected media content item to begin being presented on the media device paired with the remote control; and causing content related to the media content item to be presented on a display area of the remote control concurrent with presentation of the media content item on the media device.

In some implementations, the method further comprises automatically selecting a user profile from the user account that is associated with a plurality of user profiles based on the fingerprint.

In some implementations, the method further comprises concurrently with causing the plurality of indications of available media content items to be presented on the media device, causing first controls for navigating the plurality of indications to be presented on the display area of the remote control.

In some implementations, the method further comprises concurrently with causing the selected media content item to begin being presented on the media device paired with the remote control, causing second controls for manipulating playback of the selected media content item to be presented on the display area of the remote control.

In some implementations, the plurality of indications of available media content items are personalized recommendations identified based on the authenticated user account.

In some implementations, the plurality of indications are received from a server associated with the media content service that hosts and provides the media content items to the media device.

In some implementations, the plurality of indications are received from the media device.

In some implementations, the method further comprises: authenticating, without user input, a second user account corresponding to the identified user, wherein the second user account is associated with a second media content service that hosts and provides media content items to the media device paired with the remote control; receiving, via the remote control, an input to switch to browsing media content items available via the second media content service; and causing a second plurality of indications of media content items available via the second media content service to be presented on the media device based on the authenticated second user account.

In some implementations, the method further comprises measuring a physiological parameter of the user using a sensor of the remote control.

In some implementations, the fingerprint sensor is located on a rear surface of the remote control and wherein the display area is located on a front surface of the remote control.

In accordance with some implementations of the disclosed subject matter, a remote control device that provides enhanced remote controls is provided, the remote control device comprising a fingerprint sensor, a display area, and a hardware processor connected to the fingerprint sensor and the display area, wherein the hardware processor: detects a fingerprint of a user using the fingerprint sensor on the remote control device; identifies the user from a plurality of users based on the fingerprint; authenticates, without user input, a user account corresponding to the identified user, wherein the user account is associated with a media content service that hosts and provides media content items to a media device paired with the remote control device; causes a plurality of indications of available media content items to be presented on the media device based on the authenticated user account; receives a selection of an indication of an available media content item via the remote control device; causes the selected media content item to begin being presented on the media device paired with the remote control device; and causes content related to the media content item to be presented on the display area of the remote control concurrently with presentation of the media content item on the media device.

In accordance with some implementations of the disclosed subject matter, a non-transitory computer-readable medium containing computer executable instructions that, when executed, cause a hardware processor to provide enhanced remote controls is provided, the method comprising: detecting, at a remote control, a fingerprint of a user using a fingerprint sensor on the remote control; identifying the user from a plurality of users based on the fingerprint; authenticating, without user input, a user account corresponding to the identified user, wherein the user account is associated with a media content service that hosts and provides media content items to a media device paired with the remote control; causing a plurality of indications of available media content items to be presented on the media device based on the authenticated user account; receiving a selection of an indication of an available media content item via the remote control; causing the selected media content item to begin being presented on the media device paired with the remote control; and causing content related to the media content item to be presented on a display area of the remote control concurrently with presentation of the media content item on the media device.

In accordance with some implementations of the disclosed subject matter, a system that provides enhanced remote controls is provided, the system comprising: means for detecting, at a remote control, a fingerprint of a user using a fingerprint sensor on the remote control; means for identifying the user from a plurality of users based on the fingerprint; means for authenticating, without user input, a user account corresponding to the identified user, wherein the user account is associated with a media content service that hosts and provides media content items to a media device paired with the remote control; means for causing a plurality of indications of available media content items to be presented on the media device based on the authenticated user account; means for receiving a selection of an indication of an available media content item via the remote control; means for causing the selected media content item to begin being presented on the media device paired with the remote control; and means for causing content related to the media content item to be presented on a display area of the remote control concurrently with presentation of the media content item on the media device.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative example of a schematic diagram of a system including an enhanced remote control in accordance with some implementations of the disclosed subject matter.

FIGS. 2A and 2B show illustrative examples of a top view and a back view, respectively, of a remote control incorporating the mechanisms described herein in accordance with some implementations of the disclosed subject matter.

FIG. 3 shows an illustrative example of a process for using an enhanced remote control in accordance with some implementations of the disclosed subject matter.

FIGS. 4A and 4B show illustrative examples of user interfaces that can be presented on an enhanced remote control in accordance with some implementations of the disclosed subject matter.

### DETAILED DESCRIPTION

In accordance with various implementations, mechanisms for providing an enhanced remote control are provided.

In some implementations, the mechanisms described herein can include a remote control that can be used to browse and select available media content items, cause a selected media content item to be presented on a paired media device, manipulate playback of the media content item on the paired media device, and/or present content on the remote control device based on the media content item being presented on the paired media device.

In some implementations, a remote control can cause a user of the remote control to be authenticated to a user account of the user (e.g., a user account associated with a particular media content streaming service, and/or any other suitable user account) without user input. For example, in some implementations, the remote control can include a fingerprint sensor that can detect a fingerprint of a user holding the remote control and can identify the user based on the detected fingerprint. Continuing with this example, in some implementations, the remote control can then retrieve user credentials for one or more user accounts associated with the user that have been previously stored by the user (e.g., user credentials corresponding to multiple media content providers), and can cause the user credentials to be used to authenticate the user to the one or more user accounts. In some implementations, by authenticating the user to a user account associated with a particular media content service, the mechanisms described herein can allow the user to browse personalized content recommendations without requesting that the user enter in a password, select which user is logging in from multiple user accounts, or provide other account information to access the user account.

In some implementations, the fingerprint sensor can be positioned on a rear surface of the remote control. For example, the remote control can have a shape that conforms to the shape of the user's hand, where, upon placing the remote control in the hand of the user, the fingerprint sensor can be positioned in a region on the rear surface of the remote control that corresponds with the placement of an index finger of the user.

It should be noted that, although the fingerprint sensor is generally described herein as being located on a rear surface of the remote control, this is merely illustrative. In some implementations, the fingerprint sensor can be positioned on a front surface of the remote control. For example, the remote control can have a shape that conforms to the shape of a user's hand and that, when the remote control is held in the palm of the user's hand, orients the thumb of the user's hand to be placed on a fingerprint sensor that is positioned on the front surface of the remote control. Additionally or alternatively, in some implementations, the fingerprint sensor can be positioned on one side portion or both side portions of the remote control (e.g., to receive a fingerprint reading from either the left thumb or the right thumb of the user). Additionally or alternatively, in some implementations, the remote control can include a loop structure in which a fingerprint sensor is positioned within the loop structure to read the fingerprint of a finger placed within the loop structure.

In some implementations, the remote control can include a display area that can be used to present any suitable content. For example, in some implementations, the display area of the remote control can be used to present soft buttons (e.g., graphical user interface buttons) that can be used to control a paired media device. Note that, in some implementations, a display area of the remote control that is used to present soft buttons can replace any suitable physical buttons on the remote control (e.g., a physical pause button, a physical play button, a physical volume adjustment button, and/or any other suitable physical buttons). In some implementations, soft buttons presented on the display area of the remote control can be dynamically presented based on the content being presented on the paired media device. For example, at a first time point, the paired media device can present indications of available media content items that can be browsed by a user of the remote control. Continuing with this example, at the first time point, the display area of the remote control can present soft buttons that can be used for navigating the indications of available media content items, such as a direction pad, a selection button, and/or any other suitable navigation buttons. Continuing still further with this example, at a second time point, the paired media device can begin presenting a particular media content item (e.g., in response to selection of a particular media content item via the remote control). In some implementations, at the second time point, the display area of the remote control can switch to presenting soft buttons that can be used to manipulate playback of the media content item, such as a pause button, a volume adjustment control, and/or any other suitable playback buttons.

As another example, in some implementations, the display area can be used to present supplemental content relevant to the media content item being presented on the paired media device. As a more particular example, in an instance in which the media content item is a sports-related media item, the display area of the remote control can present player statistics, team statistics, and/or any other suitable supplemental content relevant to the sports-related media item. As another more particular example, in an instance in which the media content item is a television show or a movie, the display area of the remote control can present information about one or more actors appearing at a current time in the media content item. Note that, in some implementations, content presented on the display area of the remote control can be updated at any suitable time points as presentation of the media content item on the paired media device progresses.

Note that, in some implementations, in an instance in which the display area of the remote control presents both soft buttons for interacting with the paired media device and supplemental content, the display area can be partitioned in any suitable manner. For example, in some implementations, a top portion of the display area can be used to present dynamically generated soft buttons for interacting with the media device, and a bottom portion of the display area can be used to present supplemental content related to the media content item.

In some implementations, the remote control can include any suitable sensors that can be used to detect and/or measure any suitable physiological parameters of a user. For example, in some implementations, the remote control can include one or more light sources and light sensors that can be used to measure any suitable physiological parameters (e.g., heart rate, oxygen saturation level, carbon dioxide level, and/or any other suitable metrics). As another example, in some implementations, the remote control can include an infrared sensor that can be used to measure a current temperature of a user. In some implementations, any sensors used for measuring physiological parameters of a user can be placed in a location (e.g., on a back portion of the remote control, and/or any other suitable location) such that the physiological parameters can be measured while the user is comfortably holding the remote control.

It should be noted that, in some implementations, the fingerprint sensor described above and the sensors for detecting and/or measuring one or more physiological parameters of a user can be a single sensor. Alternatively, in some implementations, the fingerprint sensor described above and the sensors for detecting and/or measuring one or more physiological parameters of a user can be co-located at a particular portion of the remote control. For example, the remote control can have a shape that conforms to the shape of the user's hand, where, upon placing the remote control in the hand of the user, the fingerprint sensor and the sensors for detecting and/or measuring one or more physiological parameters of the user can be positioned in a region on the rear surface of the remote control that corresponds with the placement of an index finger of the user. In continuing this example, upon holding the remote control, the fingerprint of the index finger of the user can be detected and one or more physiological parameters of the user can be detected and/or measured.

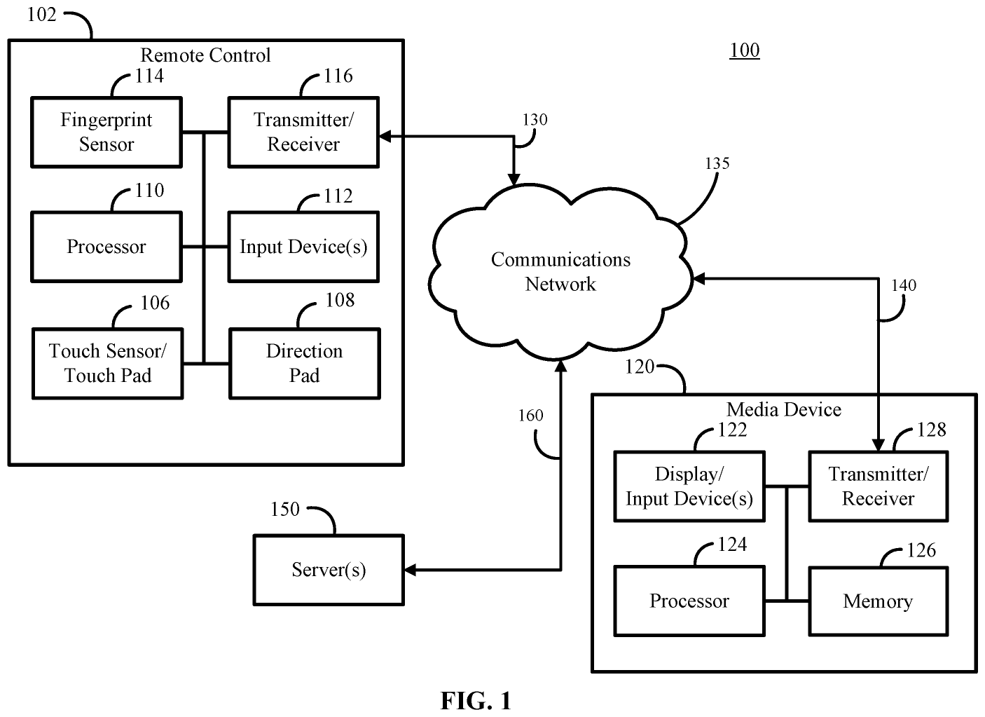

These and other features of the enhanced remote control are described in connection with FIGS. 1-4B.

Turning to FIG. 1, an illustrative example of a generalized schematic diagram of a system 100 that includes a media device, an enhanced remote control, and a server is shown in accordance with some implementations of the disclosed subject matter.

As illustrated, system 100 can include an enhanced remote control 102 that can be used to control one or more media devices, such as a media device 120. Enhanced remote control 102 can be connected by a communications link 130 to a communications network 135 that can be linked via a communications link 140 to media device 120. Additionally, a server 150 can be connected by a communications link 160 to communications network 135 such that remote control 102 and/or media device 120 can communicate with server 150.

In a more particular example, as shown in FIG. 1, enhanced remote control 102 can include a touch sensor 106, a directional pad 108 (sometimes referred to herein as a “d-pad”) or any other suitable directional input region, a processor 110, one or more input devices 112, a fingerprint sensor 114, and a transmitter/receiver 116, which can be interconnected.

In some implementations, enhanced remote control 102 can include memory and/or storage (not shown) for storing a computer program for controlling processor 110. For example, the computer program can be stored in read-only memory (ROM), electrically programmable read only memory (EPROM), electrically erasable programmable read only memory (EEPROM), flash memory, etc.

Processor 110 can use the computer program to cause signals to be transmitted from enhanced remote control 102 through communications link 130 and communications network 135 to media device 120 via communications link 140. These signals can be transmitted using transmitter/receiver 116, which can include one or more transmitters, receivers, antennas, transmitter/receivers, etc. Transmitter/receiver 116 can transmit and/or receive signals using any suitable technologies and/or frequencies. For example, transmitter/receiver 116 can transmit and/or receive radio signals, infrared signals, near-infrared signals, ultrasonic signals, etc.

Communications links 130, 140, and 160 can be any communications links suitable for communicating data between remote control 102, media device 120, and/or server 150, such as radio frequency links, infrared links, near-infrared links, wireless links, network links, any other suitable communications links, or any suitable combination of such links. In some implementations, communication link 130, communication link 140, and communication link 160 can be the same communication link or different communication links. For example, a radio signal can be sent from remote control 102 through communications network 135 (e.g., a space between remote control 102 and media device 120), which can then be received at media device 120. In such an example, communication link 130 and communication link 140 are the same.

As another example, a radio signal can be sent from remote control 102 and received at a converter (not shown) that converts the radio signal to a near-infrared signal. In such an example, the converter can transmit the near-infrared signal, which can then be received by media device 120. In this example, communication link 130 is the radio signal, and communication link 140 is the near-infrared signal and the converter is part of communications network 135.

Referring back to remote control 102, remote control 102 can include a touch sensor 106. Touch sensor 106 can include one or more touch sensors that are configured to detect when a surface is contacted by an object, such as a user's thumb. In such an implementation, each of the one or more touch sensors can be a capacitance-based touch sensor, a resistance-based touch sensor, a pressure-based touch sensor, a light-based sensor, etc. In a more particular implementation, touch sensor 106 can detect when the surface is contacted by a conductive object, such as human skin.

Processor 110 can receive output signals from touch sensor 106 to detect if touch sensor 106 has been activated. In some implementations, the output from touch sensor can be a binary indication of whether a touch has been registered by touch sensor 106. Additionally, in some implementations, a direction of motion and/or a speed of motion of an object contacting touch sensor 106 can be detected based on the output from touch sensor 106. For example, outputs from multiple touch sensors that make up touch sensor 106 can be detected and a pattern of the output can be interpreted to determine a direction of motion and/or a speed of the motion. In a more particular example, if a user moves her thumb from left to right across touch sensor 106, sensors located on the left side of touch sensor 106 can be activated prior to touch sensors on the right side of touch sensor 106. In this example, motion can be detected by determining a pattern in which the touch sensors are activated.

In some implementations, touch sensor 106 can also correspond to a selectable button. For example, in an instance in which a display associated with remote control 102 presents an OK button, touch sensor 106 can correspond to the OK button.

In some implementations, touch sensor 106 can also correspond to a touchpad that detects alphanumeric characters inputted by a user of remote control 102. For example, in some implementations, touch sensor 106 can use a character recognition technique to detect alphanumeric characters that have been drawn on the surface of touch sensor 106 using a finger of the user of remote control 102. In a more particular example, in an instance in which the user desires to enter search terms, website addresses, user credentials for user accounts, and/or any other suitable information, alphanumeric characters can be inputted in response to the character recognition technique detecting alphanumeric characters that have been drawn on the surface of touch sensor 106 using a finger of the user of remote control 102. It should be noted that, in some implementations, the character recognition technique can be provided on a separate track pad or touch sensor from touch sensor 106.

In some implementations, remote control 102 can include a directional pad 108. Directional pad 108 can include a number of switches that, when activated, indicate a directional input. For example, directional pad 108 can include a button that a user can press to indicate a direction. This button can activate one or more of the switches, and a signal from the one or more switches can be correlated by processor 110 with a direction indicated by pressing the button.

Directional pad 108 and processor 110 can be configured to accept any suitable number of inputs for various directions in accordance with some implementations. For example, processor 110 can be configured to detect inputs in four directions (e.g., up, down, left and right) from directional pad 108. In another example, processor 110 can be configured to detect eight directional inputs (e.g., up, down, left, right and intermediate directions, such as, top-right diagonal, top-left diagonal, bottom-right diagonal, and bottom-left diagonal) from directional pad 108. In yet another example, processor 110 can be configured to detect inputs in any arbitrary direction from directional pad 108. In such an example, directional pad 108 can include touch sensors that can be used to detect an arbitrary position of an input to directional pad 108.

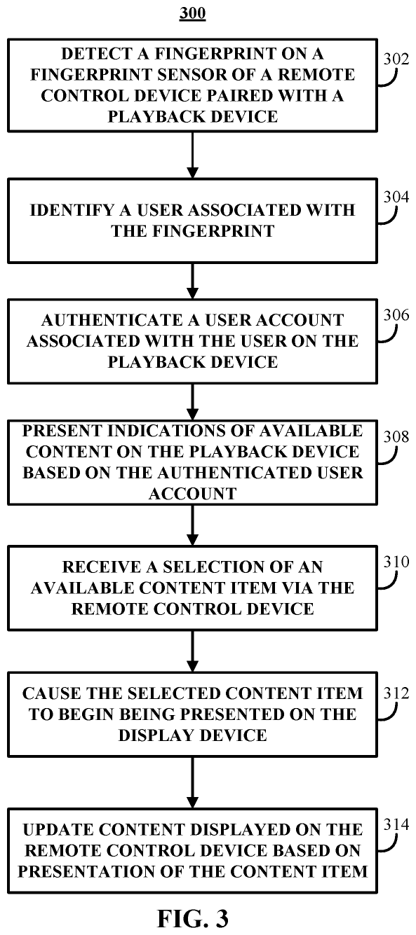

In some implementations, remote control 102 can include a fingerprint sensor 114 or any other suitable component capable of detecting user fingerprints. In some implementations, fingerprint sensor 114 can be a capacitive fingerprint sensor, an optical fingerprint sensor, and/or any other suitable type of sensor. In some implementations, processor 110 can be configured to receive a fingerprint detected using fingerprint sensor 114 and perform any suitable action(s) based on the received fingerprint. For example, as described below in more detail in connection with FIG. 3, in some implementations, processor 110 can identify a particular user whose stored fingerprint corresponds to the received fingerprint. Continuing with this example, in some implementations, processor 110 can then cause an account associated with the particular user to be authenticated with stored user credentials (e.g., a user account associated with a particular video content streaming service, and/or any other suitable user account). In a more particular example, upon placing remote control 102 in the hand of the user, process 110 can receive a fingerprint of the user using fingerprint sensor 114 and can automatically authenticate the multiple user accounts associated with the user corresponding to the received fingerprint (e.g., login the user to multiple user accounts that are each associated with a content provider and select the corresponding user profile corresponding to the received fingerprint).

In some implementations, processor 110 can be configured to detect motion (e.g., rotational motion, linear motion, and/or orientation) based on signals from any suitable motion sensor and using any suitable techniques. When the user moves remote control 102 containing a motion sensor (e.g., an accelerometer, a gyroscope, or a magnetometer), the motion sensor can transmit motion information and/or orientation information relating to remote control 102 to processor 110. For example, rotational movement of remote control 102 can be detected by processor 110 using signals from one or more gyroscopes that can detect rotational movement of remote control 102. As another example, linear movement and/or orientation of remote control 102 can be detected by processor 110 using signals from one or more accelerometers that can detect linear movement and/or orientation of remote control 100. As yet another example, movement and/or orientation of remote control 102 can be detected by processor 110 using signals from one or more magnetometers that can detect movement and/or orientation of remote control 100 with respect to magnetic poles. As a further example, rotational movement and linear movement/orientation of remote control 102 can be detected by processor 110 using a combination of one or more gyroscopes, one or more accelerometers, and/or one or more magnetometers.

In some implementations, remote control 102 can detect particular gestures performed by the user. For example, remote control 102 containing a motion sensor can transmit information indicating that the user is shaking remote control 102 to processor 110 and, in response to receiving the motion information, processor 110 can switch remote control 102 from one operational mode to another operational mode.

In some implementations, it should be noted that enhanced remote control 102 can include any other suitable input devices 112. Input devices 112 can include other suitable input features, such as an alphanumeric keypad, a power button, an input button, channel buttons, volume buttons, a volume mute button, directional buttons, media playback buttons (e.g., rewind, pause, play, and fast-forward buttons), a dedicated button that accesses downloadable applications for use by the media device, a microphone or other suitable audio input, a camera, etc. For example, in some implementations, remote control 102 can include a microphone that can be used for any suitable purposes. As a more particular example, in some implementations, the microphone can be used to receive voice queries (e.g., to begin playing a particular media content item, to execute a search query, and/or any other suitable voice query), which can be processed either by remote control 102 or transmitted from remote control 102 to another device for processing (e.g., to media device 120, to server 150, and/or to any other suitable device). As another more particular example, in some implementations, the microphone can be used to detect any suitable audible sound (e.g., clapping, etc.) that can be used as a trigger to present an indication of a location of remote control 102 (e.g., by causing the remote control to emit an audible tone or beep). In some implementations, input devices 112 can include hardware buttons and/or software buttons (e.g., programmable buttons). In some implementations, input devices 112 can also include other inputs, such as, a computer keyboard, a cursor-controller, a dial, a switchbank, a lever, a touchscreen, and/or any other suitable input device.

In a more particular example, remote control 102 can include a speaker that emits an audible tone. For example, using a network controller integrated within remote control 102, a media device paired with remote control 102 can transmit a signal to remote control 102 that causes the speaker of remote control 102 to emit an audible tone, thereby indicating the location of remote control 102 to a user of remote control 102. In another example, using a network controller integrated within remote control 102, an application executing on a computing device can request that a server transmit an instruction to remote control 102 (or to a media device that is paired with remote control 102) that causes the speaker of remote control 102 to emit an audible tone, thereby indicating the location of remote control 102 to a user of remote control 102.

System 100 can include one or more media devices 120, such as a media device for viewing media content listings and/or obtaining and presenting content items from various sources (e.g., broadcast content, on-demand content, locally stored content, Internet content, streamed content, live-streamed content, etc.). For example, media device 120 can be implemented as a television, a smart television, a set-top box, a streaming media device, a digital media receiver, a computer, a gaming console, an optical media player, etc. Enhanced remote control 102 and media device 120 can be local to each other or remote from each other. For example, enhanced remote control 102 and media device 120 can be located in the same room.

More particularly, media device 120 can include a display/input device 122, a processor 124, memory 126, and one or more transmitters, receivers, and/or transmitter/receivers 128, which can be interconnected.

In some implementations, media device 120 can include a storage device, such as a hard drive, a digital video recorder, a solid-state storage device, a removable storage device, or any other suitable device for storing guidance information and/or remote control instructions. In a more particular example, the storage device can store a computer program for controlling processor 124 in media device 120 (e.g., responsive to instructions received from enhanced remote control 102).

Processor 124 can use the computer program to present content on display/input device 122 and control an interface that allows a user to interact with the content and to send and receive data through communication link 140 using transmitter/receiver 128. In some implementations, transmitter/receiver 128 can transmit and/or receive radio signals, infrared signals, near-infrared signals, ultrasonic signals, etc. In cases where transmitter/receiver 116 and transmitter/receiver 128 operate using different types of signals, a converter (not shown) can be used to convert instructions transmitted using one type of signal (e.g., a radio signal) to another type of signal (e.g., a near-infrared signal). It should be noted that data received through communications link 140 or any other communications links can be received from any suitable source. It should also be noted that transmitter/receiver 116 and transmitter/receiver 128 can operate using any suitable type of signals or combination thereof, including digital signals, analog signals, etc.

Display/input device 122 can include input devices such as a computer keyboard, a cursor-controller, one or more buttons, a dial, a switchbank, a lever, a touchscreen, and/or any other suitable input device.

In some implementations, instructions issued by remote control 102 can be formatted based on a model and/or brand of a media device 120 that is being controlled. For example, remote control 102 can be programmed with different codes and can act as a universal remote control for controlling different types of media devices. In some implementations, formatting can be performed by a converter (not shown) that converts signals transmitted by remote control 102 into signals used by a particular media device 120.

In a more particular example, remote control 102 and media device 120 can be any of a general purpose device such as a computer or a special purpose device such as a remote control, a smartphone, a tablet computer, a set-top box, a smart TV, a game console, a digital media receiver, a server, etc., or any suitable combination of such devices. Any of these general or special purpose devices can include any suitable components such as a hardware processor (which can be a microprocessor, digital signal processor, a controller, etc.), memory, communication interfaces, display controllers, input devices, etc. For example, media device 120 can be implemented as a set-top box, a digital media receiver, a smart TV, a television, a laptop computer, a personal computer, a server, a smartphone, a tablet computer, a game console, etc.

Note that, in some implementations, remote control 102 and media device 120 can transmit and receive instructions via instances of an application executing on each of remote control 102 and media device 120. In some implementations, the application can perform any suitable function(s), such as formatting instructions based on a model and/or brand of media device 120 that is being controlled, querying server 150, initiating particular media content services, managing storage of user credentials for different users and different media content services, and/or performing any other suitable function(s).

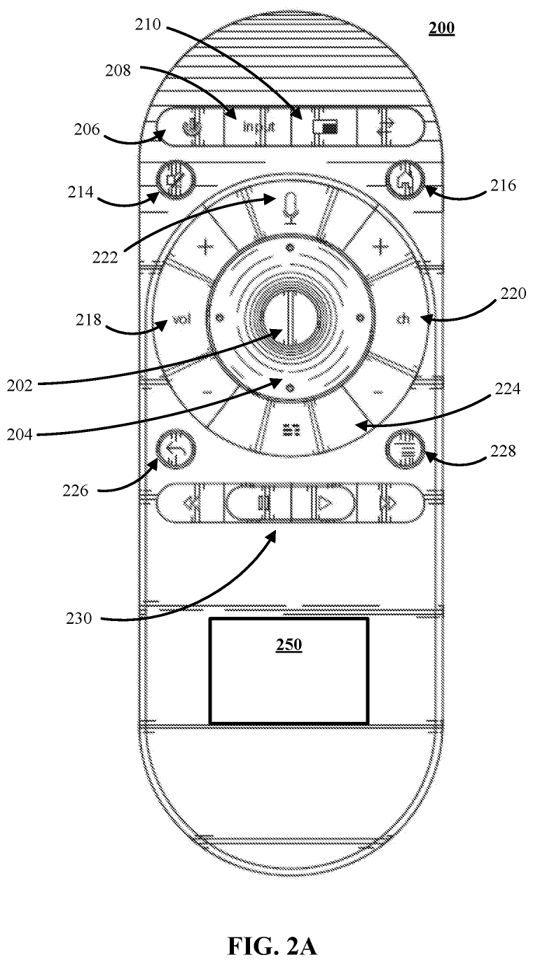

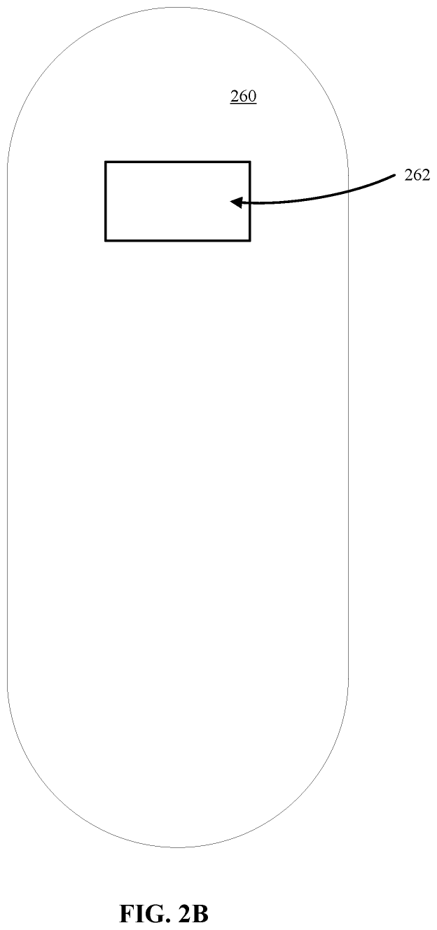

Turning to FIG. 2A, an illustrative example of a top view of a remote control 200 embodying remote control 102 described in connection with FIG. 1 is shown in accordance with some implementations of the disclosed subject matter. In some implementations, remote control 200 can include various buttons, such as buttons 202-230, which can include a selectable touch sensitive button 202 and a directional pad 204. Note that, in some implementations, any of buttons 202-230 can be omitted, and, in some such implementations, functions described herein as relating to buttons 202-230 can be perusing soft buttons dynamically generated on a display area 250 of remote control 200, as described below.

In some implementations, selectable touch sensitive button 202 can include a touch sensor, such as touch sensor 106 of FIG. 1 that can detect touches of the surface of selectable touch sensitive button 202. Additionally, a processor, such as processor 110 of FIG. 1, can detect a depression of touch sensitive button 202 as a separate operation of touch sensitive button 202. For example, depressing selectable touch sensitive button 202 can complete (or inhibit) a circuit, and the completion of the circuit can be detected by processor 110. Any other suitable technique can also be used to indicate that touch sensitive button 202 has been pressed by the user. For example, depressing touch sensitive button 202 can change a capacitance of a circuit, activate a piezoelectric transducer, create a sound, etc.

As yet another example, a combination of signals can be required to indicate a press of selectable touch sensitive button 202. In a particular example, processor 110 can require both that a touch is sensed at touch sensitive button 202 and that a press of touch sensitive button 202 is sensed before responding to a button press of touch sensitive button 202. In some cases, this can inhibit accidental presses of touch sensitive button 202 (e.g., pressing by an inanimate object, such as a book, that is placed on top of remote control 200) from being interpreted by processor 110 as button presses by the user.

Remote control 200 can also include directional pad 204 which can be pressed to indicate directional inputs. For example, depressing directional pad 204 at a particular point can complete (or inhibit) one or more circuits, and the completion of the one or more circuits can be detected by processor 110. Processor 110 can then determine which direction was indicated based on which circuit(s) is completed. For example, if a right side (as shown in FIG. 2A) of the directional pad is depressed, this can complete a circuit that indicates to processor 110 that the right side of the directional pad is pressed. In another example, directional pad 204 can include one or more touch sensors that detect directional inputs from the user (e.g., the user's thumb sliding from touch sensitive button 202 to a right portion of directional pad 204).

In some implementations, remote control 200 can also include a motion sensor (not shown) for sensing rotational and/or linear motion of remote control 200, and/or orientation of remote control 200. For example, when the user moves remote control 200 containing the motion sensor (e.g., a gyroscope, an accelerometer, a magnetometer, etc.), the motion sensor can transmit motion and/or orientation information relating to remote control 200 to processor 110. As described herein, processor 110 can use the motion sensor to detect signals indicative of motion of remote control 200, detect signals indicative of the orientation of remote control (e.g., which portion of remote control 200 is facing up), detect signals indicative of particular gestures (e.g., shaking, swinging, etc.), etc.

In some implementations, remote control 200 can include other suitable input buttons in addition to touch sensitive button 202 and directional pad 204.

In some implementations, remote control 200 can include a power button 206 for controlling a power state of a media device, such as media device 120. For example, if power button 206 is depressed, processor 110 can cause a signal to be transmitted to media device 120 to power on (e.g., from an off or sleep state). Additionally, in some implementations, a selector (not shown) can be included that can be used to select a device from multiple devices to power on by pressing power button 206. Such a selector can be, for example, a sliding switch, buttons that each correspond to various media devices, etc. In some implementations, remote control 200 can include an indicator that indicates to a user which media device is currently selected.

In some implementations, remote control 200 can include an input button 208 for controlling a selected input of media device 120. For example, if media device 120 is a television, it can have multiple inputs such as one or more High Definition Multimedia Interface (HDMI) inputs, one or more coaxial inputs, one or more component video inputs, one or more DisplayPort inputs, one or more fiber optic inputs, etc. Pressing input button 208 can cause processor 110 to transmit an instruction to media device 120 to change a selected input. Selecting an input can be performed using any suitable technique. For example, in some implementations, after pressing input button 208, a list of selectable inputs can be displayed on a display connected to media device 120 and a user can select a desired input by either holding down and/or repeatedly pressing input button 208, or by using directional pad 204 to navigate to a particular input and depressing touch sensitive 202 to select the particular input.

In some implementations, remote control 200 can include a picture-in-picture (PiP) button 210. For example, if a user depresses PiP button 210, processor 110 can transmit an instruction to media device 120 to display content from a second source (e.g., a second channel) over content from a first source currently being displayed (e.g., a first channel). In such an example, the content from the second source can be displayed, for instance, in a corner of a display connected to media device 120.

In some implementations, remote control 200 can include a mute button 214 for muting the sound output from media device 120.

In some implementations, remote control 200 can include a home button 216 for returning to a home screen of media device 120 and/or exiting from a current screen and returning to a main input. For example, if media device 120 that is being controlled using remote control 200 is a digital media receiver running an operating system that has a home screen, an instruction transmitted in response to pressing home button 216 can cause the digital media receiver to go to the home screen. As another example, if media device 120 that is being controlled using remote control 200 is a set-top box from a cable provider, an instruction transmitted in response to pressing home button 216 can cause the set-top box to exit any screen that is currently being displayed and return to a last channel that was tuned by the set-top box.

In some implementations, if media device 120 is currently running an application, pressing home button 216 can cause media device 120 to display a home screen of the application. Additionally, in such an implementation, pressing and holding home button 216 can cause media device 120 to go to a home screen of media device 120.

In some implementations, remote control 200 can include a volume button 218 and a channel button 220. Volume button 218 and channel button 220 can be used to control a volume output and a channel output respectively of media device 120. These buttons can be located on either side of directional pad 204. This can allow a user to reach volume button 218 and channel button 220 if the user holds remote control 200 in her hand with her thumb near touch sensitive button 202 and directional pad 204.

In some implementations, remote control 200 can include a voice command button 222 for initiating a voice command function on media device 120. After pressing voice command button 222, a user can be prompted to speak a voice command for causing media device 120 to perform some function. Any suitable techniques can be used to prompt a user for a voice command, such as, a sound, an image, etc. Alternatively, a user may not be prompted to speak a voice command, but pressing the button can cause an instruction to media device 120 to prepare to receive a voice command. Media device 120 and/or remote control 200 can be configured to recognize any suitable voice commands. For example, commands that replicate actions caused by pressing buttons on remote 200 can be recognized. As another example, a user can initiate a search using a voice command. As yet another example, a user can tune to a particular channel by number and/or by name (e.g., channel 451, channel 2, “CBA,” “Food Channel,” etc.).

In some implementations, a microphone for receiving voice commands can be included in media device 120. Additionally or alternatively, a microphone for receiving voice commands can be included in remote control 200. If a microphone is included in remote control 200, a voice command can be interpreted by processor 110 and/or can be sent to media device 120 for interpretation. Additionally, in some implementations, the microphone can be used for detecting a trigger sound (e.g., clapping, and/or any other suitable trigger sound). In some implementations, in response to detecting the trigger sound, remote control 200 can be programmed to present an indication of a location of remote control 200, for example, by emitting a particular tone, beep, or other audible sound.

In some implementations, remote control 200 can include a guide button 224 that can initiate a program guide of available media content. For example, such a guide can be an electronic program guide that displays available programming to a user and can be organized based on time, channel, category, etc. As another example, such a guide can include a list of over-the-top content, such as television shows and/or movies, that are available to be retrieved and displayed by media device 120.

In some implementations, remote control 200 can include a back button 226 for navigating back to a previously displayed screen. For example, if a user is navigating a menu on media device 120, pressing back button 226 can cause the media device to go back to a previous level of the menu from which a current level was selected. As another example, if a user switches a channel that is tuned by media device 120 from a first channel to a second channel, pressing back can cause media device 120 to switch back to the first channel. As yet another example, if media device 120 is running an application, back button 226 can have a functionality assigned by the application, which can include a back functionality.

In some implementations, remote control 200 can include a menu button 228 for calling up a menu on media device 120. For example, pressing menu button 228 can cause media device 120 to open a menu. As another example, if media device 120 is running an application, pressing menu button 228 can cause additional options and/or a menu related to the application to be presented to the user.

In some implementations, remote control 200 can include media buttons 230 for controlling playback of media by media device 120. For example, media buttons 230 can include a play button, a pause button, a fast-forward button, a rewind button, a skip forward button, any other suitable media buttons, and/or any suitable combination thereof. As illustrated in FIG. 2A, buttons that a user may use more commonly (e.g., play and pause buttons) can be centrally located and raised as compared to less commonly used buttons (e.g., rewind and fast forward). Additionally or alternatively, different media buttons can have different shapes to differentiate the buttons from one another. These features can facilitate a user in pressing a correct button while the user's gaze is not directed at remote control 200, but is instead directed at, for example, a display connected to media device 120.

In some implementations, certain buttons can have embossed lettering and/or symbols (e.g., “+” and “−” on channel button 220), and/or the buttons themselves can be raised (e.g., buttons 214, 216, 226 and 228) so that they can be more easily identified by a user without looking at remote control 200.

In some implementations, remote control 200 can have a display area 250 on which any suitable content can be presented. Note that, although display area 250 is shown in addition to the other buttons of remote control 200 discussed above, in some implementations, remote control 200 can dynamically generate soft buttons which are presented on display area 250 in lieu of any of the physical buttons shown in FIG. 2A and discussed above. For example, in some implementations, soft buttons representing a direction pad can be presented on display area 250. As another example, in some implementations, soft buttons for manipulating playback of media content (e.g., to rewind or fast-forward, pause playback, resume playback, change a volume of audio content, and/or any other suitable buttons for manipulating playback) can be presented on display area 250. In continuing this example, such soft buttons for manipulating playback of media content can be presented on display area 250 rather than providing media buttons 230. In some implementations, content presented on display area 250 can be determined contextually based on content presented on media device 120, as described below in connection with FIG. 3. Note that, in some implementations, display area 250 can span any suitable portion of remote control 200. For example, in some implementations, display area 250 can span a majority of remote control 200.

In some implementations, remote control 200 can include a trackpad for receiving alphanumeric characters from a user of remote control 200. For example, in some implementations, the trackpad can include any suitable keys corresponding to any suitable letters, numbers, or other characters, which can be used by the user to enter search terms, website addresses, user credentials for user accounts, and/or any other suitable information. In some implementations, remote control 200 and/or a media device to which remote control 200 is paired can use any suitable text completion technique(s) to auto-fill text as it is being entered by the user. For example, in an instance in which the user is entering a name of a television show, remote control 200 and/or the media device to which remote control 200 is paired can use any suitable auto-fill or text prediction algorithm(s) to update a list of suggestions as the user is entering characters.

Turning to FIG. 2B, an example of a back view 260 of remote control 200 is shown in accordance with some implementations of the disclosed subject matter. As illustrated, the back of remote control 200 can include a fingerprint sensor 262. In some implementations, fingerprint sensor 262 can be positioned at a location on the back of remote control 200 such that an index finger of a user can be positioned against fingerprint sensor 262 when the user holds remote control 200. As described above in connection with FIG. 1, in some implementations fingerprint sensor 262 can be a capacitive fingerprint sensor, an optical fingerprint sensor, and/or any other suitable type of fingerprint sensor.

Note that, in some implementations, remote control 200 can include any other suitable sensors for calculating one or more physiological metrics. For example, in some implementations, remote control 200 can include a light source and a light sensor that detects and measures reflected light. In some implementations, the light source can emit light of any suitable wavelength, such as optical light, infrared light, and/or any other suitable wavelength. In some implementations, the light source and the light sensor can be used to calculate any suitable physiological metrics, such as a heart rate of a user, an oxygen saturation value of a user, a carbon dioxide saturation level of a user, and/or any other suitable physiological metric. Note that, in some implementations, the same light source and light sensor can be used to calculate multiple physiological metrics, such as a heart rate value and an oxygen saturation value. Additionally, note that, in some implementations, remote control 200 can include a first light source and light sensor pair that operates with optical light that is used to calculate a first physiological metric (e.g., heart rate), and a second light source and light sensor pair that operates with infrared light that is used to calculate a second physiological metric (e.g., carbon dioxide level). As another example, in some implementations, remote control 200 can include a temperature sensor (e.g., an infrared sensor) that can measure a temperature of a user.

It should be noted that, in some implementations, fingerprint sensor 262 described above and the sensors for detecting and/or measuring one or more physiological parameters of a user can be a single sensor. Alternatively, in some implementations, fingerprint sensor 262 described above and the sensors for detecting and/or measuring one or more physiological parameters of a user can be co-located at a particular portion of the remote control. For example, remote control 200 can have a shape that conforms to the shape of the user's hand, where, upon placing remote control 200 in the hand of the user, fingerprint sensor 262 and the sensors for detecting and/or measuring one or more physiological parameters of the user can be positioned in a region on the rear surface of remote control 200 that corresponds with the placement of an index finger of the user. In continuing this example, upon holding remote control 200, the fingerprint of the index finger of the user can be detected and one or more physiological parameters of the user can be detected and/or measured.

In some implementations, calculated physiological metrics can be presented and/or stored in any suitable manner. For example, in some implementations, a measured physiological metric (e.g., a current heart rate of a user, a current temperature of a user, a current oxygen saturation of a user, a current carbon dioxide level of a user, a current blood pressure of a user, and/or any other suitable physiological metric) can be presented on display 250 of remote control 200. As another example, in some implementations, a measured physiological metric can be stored in association with a user account to which remote control 200 has been authenticated. As a more particular example, in an instance in which remote control 200 has authenticated a particular user to a user account (e.g., using fingerprint sensor 262, as shown in FIG. 2B and discussed below in connection with FIG. 3), remote control 200 can cause the measured physiological metric to be stored in a health data area associated with the user account. Continuing with this particular example, in some implementations, the stored health data can be stored in connection with a current date or time of the measurement. In some such implementations, the health data can be accessed by logging in to the user account from any suitable user device (e.g., from a mobile phone, from a tablet computer, from a wearable computer, from a desktop computer, and/or any other suitable user device).

Turning to FIG. 3, an illustrative example 300 of a process for using a remote control device is shown in accordance with some implementations of the disclosed subject matter.

Process 300 can begin at 302 by detecting a fingerprint on a fingerprint sensor of a remote control device paired with a media device. In some implementations, the media device can be any suitable type of media device, such as a television, a smart television, a streaming media device connected to a television, speakers, a projector, and/or any other suitable type of media device. As shown in and described above in connection with FIGS. 1 and 2B, the fingerprint sensor can be any suitable type of fingerprint sensor, such as a capacitive fingerprint sensor, an optical fingerprint sensor, and/or any other suitable type of fingerprint sensor.

Additionally, as shown in and discussed above in connection with FIG. 2B, the fingerprint sensor can be positioned at any location on the remote control device, such as on an upper portion of a back side of the remote control device, such that a finger of a user is comfortably placed on the fingerprint sensor when the user is holding the remote control device. In a more particular example, the remote control device can have a shape that generally conforms to the shape of the user's hand, where, upon placing the remote control in the hand of the user, the fingerprint sensor can be positioned in a region on the rear surface of the remote control device that corresponds with the placement of an index finger of the user. In another more particular example, the remote control device can have a loop structure formed on the rear surface of the remote control device, where the fingerprint sensor is integrated into the loop structure such that a fingerprint can be detected upon placing a finger onto the fingerprint sensor in the loop structure.

It should be noted that, although the fingerprint sensor is generally described herein as being located on a rear surface of the remote control device, this is merely illustrative. In some implementations, the fingerprint sensor can be positioned on a front surface of the remote control device. For example, the remote control device can have a shape that conforms to the shape of a user's hand and that, when the remote control device is held in the palm of the user's hand, orients the thumb of the user's hand to be placed on a fingerprint sensor that is positioned on the front surface of the remote control device. Additionally or alternatively, in some implementations, the fingerprint sensor can be positioned on one side portion or both side portions of the remote control device (e.g., to receive a fingerprint reading from either the left thumb or the right thumb of the user).

In some implementations, the fingerprint sensor can detect any suitable information corresponding to the fingerprint, such as locations of ridges and valleys of the fingerprint, and/or any other suitable information.

At 304, process 300 can identify a user associated with the fingerprint. In some implementations, process 300 can identify the user in any suitable manner. For example, in some implementations, process 300 can compare any suitable characteristics or features of the fingerprints (e.g., locations of ridges and/or valleys in the detected fingerprint, and/or any other suitable characteristics or features) to characteristics or features of stored fingerprints of known users of the remote control device. As a more particular example, in some implementations, the remote control device can receive (e.g., during an initial setup or configuration of the remote control device) and store fingerprints of a group of users, and process 300 can identify a user in the group of users whose stored fingerprint (or characteristics of the stored fingerprint) matches the detected fingerprint (or matches characteristics of the detected fingerprint). Note that, in some implementations, the group of users can include any suitable number of users (e.g., one, two, five, ten, and/or any other suitable number). In some implementations, fingerprints of users can be added and stored at any suitable time(s). Additionally, note that, in some implementations, the stored fingerprints can be stored in any suitable location, such as in memory of the remote control device, in memory of the paired media device, on a server which the remote control device can query, and/or in any other suitable location.

At 306, process 300 can authenticate a user account associated with the identified user on the media device. In some instances, the user account can be a user account associated with a particular media content service, such as a particular media content streaming service. Note that, in some instances, process 300 can authenticate multiple user accounts associated with the identified user, where each user account corresponds to a different media content service. For example, in some implementations, process 300 can authenticate a first user account associated with the identified user that corresponds to a first media content streaming service and can authenticate a second user account associated with the identified user that corresponds to a second media content streaming service.

In some implementations, process 300 can authenticate the user account in any suitable manner and using any suitable technique(s). For example, in some implementations, process 300 can log in to the user account using user credentials associated with the user account that have been previously entered by the user and stored for future use. In some such implementations, the user credentials can be stored in any suitable location, such as in memory of the remote control device, in memory of the media device, on a server which the remote control device is in communication with, and/or in any other suitable location.

In a more particular example, during configuration of the media device and/or the remote control device, the user can be prompted to provide user account information (e.g., usernames and passwords) for one or more media content streaming services, content provider services, payment services, etc. Such user account information or portion of the user account information can be associated with a provided fingerprint (e.g., where the user account information is stored in the media device, stored in the remote control device, stored on a remote network location, etc.). For example, a user having a stored fingerprint can associate particular user account information for authentication (e.g., a preferred payment service, two preferred media content providers, etc.).

In response to receiving a fingerprint using the fingerprint sensor of the remote control device and identifying a user associated with the received fingerprint, the remote control device can cause the user accounts associated with the identified user to be authenticated on the media device and the remote control device. In turn, the user of the remote control device can be provided with, for example, content recommendations and available content items from services corresponding to the authenticated user accounts.

In continuing this example, it should be noted that each user account can be associated with multiple user profiles (e.g., a parent profile and a child profile). In some implementations, a default user profile can be associated with the identifier user (e.g., the parent user profile). In some implementations, when initially inputting user account information, the user of the remote control device can be prompted to select a user profile of the user account for association with the identifier user and the fingerprint information.

At 308, process 300 can present indications of available content on the media device based on the authenticated user account. For example, in an instance in which the authenticated user account is a user account of the user corresponding to a particular media content streaming service, process 300 can cause indications of content available through the particular media content service to be presented based on the authenticated user account. Continuing with this example, process 300 can cause indications of available content that is recommended to the user based on a previous viewing history associated with the user account. In some implementations, process 300 can cause the indications to be presented in any suitable manner. For example, in some implementations, process 300 can present indications of available content in a series of rows, where each row corresponds to a different genre of content and/or a different type of recommendation personalized based on the user account. As a more particular example, in some implementations, process 300 can present a first row of available content that indicates media content items the user previously started and has not finished (e.g., a next episode in a television series, an episode or a move the user previously started but did not finish, etc.). As another more particular example, in some implementations process 300 can present a second row of available content that is recommended for the user based on a previous viewing history, such as content items related to topics of content items previously viewed, content items that include actors that appear in previously viewed content items, and/or any other suitable personalized recommendations. As yet another more particular example, in some implementations process 300 can present a third row of available content that includes recommendations based on any other suitable criteria or factors, such as based on popularity with other users, popularity with users in a similar demographic of the user associated with the authenticated user account, and/or based on any other suitable criteria or factors.

Note that, in some implementations, in instances in which multiple media content services (e.g., multiple media content streaming services) are available, the remote control device can allow the user to toggle between media content services. In some such implementations, a user account corresponding to each media content service can be authenticated, thereby allowing the user to browse personalized indications of available content in each media content service without separately logging in to each user account. In some such implementations, the user can switch from browsing a first media content service to a second media content service in any suitable manner, for example, by pressing a particular key or a particular sequence of keys on the remote control device.

Additionally, note that, in some implementations, in response to causing the indications of available content items to be presented on the media device, process 300 can cause any suitable soft buttons or user interface controls for navigating the available content items to be presented in the display area of the remote control. For example, in some implementations, process 300 can cause a directional pad to be presented on the display area of the remote control, a selection button to be presented on the display area of the remote control, and/or any other suitable user interface controls.

At 310, process 300 can receive a selection of an available content item via the remote control device. In some implementations, process 300 can receive the selection in any suitable manner. For example, in some implementations, process 300 can receive the selection by determining that a highlighted available content item has been selected via a button press received by the remote control device. Note that, in instances in which selection of the available content item is received via a button press, the button can be a physical button on the remote control device or a soft button presented on a display area of the remote control device.

At 312, process 300 can cause the selected content item to begin being presented on the paired media device. In some implementations, process 300 can cause the selected content item to begin being presented in any suitable manner and using any suitable technique(s). For example, in some implementations, process 300 can transmit an identifier of the selected content item to a server that hosts the selected content item. Continuing with this example, in some implementations, the server can then begin streaming the selected content item to the media device. In another example, in some implementations, process 300 can launch an application associated with a media content service that provides the selected content item on a media device, automatically authenticate the corresponding user account of the media content service and automatically select a profile associated with the user account of the media content service based on the identified user associated with the received fingerprint, and transmitting an instruction to the application executing on the media device that obtains the selected content item from the media content service and causes the media device to begin playing back the selected content item.

At 314, process 300 can update content displayed on the remote control device based on presentation of the content item on the paired media device. In some implementations, process 300 can update content displayed on any suitable portion of the remote control device, such as a display area of the remote control device, as shown in and described above in connection with FIG. 2A.

In some implementations, process 300 can update content displayed on the remote control device in any suitable manner. For example, in some implementations, process 300 can cause controls that correspond to the content being presented on the media device to be presented on the remote control device. As a more particular example, in some implementations, process 300 can cause controls for manipulating playback of the media content item to be presented on the remote control device. As a specific example, during playback of the media content item, process 300 can cause a pause button to be presented on the remote control device. Continuing further with this specific example, when playback of the media content item has been paused, process 300 can cause the pause button to be replaced by a play button on the remote control device.

As another example, in some implementations, process 300 can cause supplemental content that is relevant to the media content item being presented on the media device to be presented on the remote control device. As a more particular example, in some implementations, in an instance in which the media content item is a sports game, process 300 can cause information about the game and/or the teams playing in the game to be presented, such as statistics of the teams participating in the game, statistics of players participating in the game, statistics of other teams in the same league that are not participating in the game, and/or any other suitable information. As another more particular example, in some implementations, in an instance in which the media content item is a television episode or a movie, process 300 can cause information related to actors appearing in the media content item to be presented, such as names of the actors, indications of other shows or movies the actors have appeared in, and/or any other suitable actor information. As yet another more particular example, in some implementations, in an instance in which the media content item includes background music, process 300 can cause an identifier of the music to be presented on the remote control device.

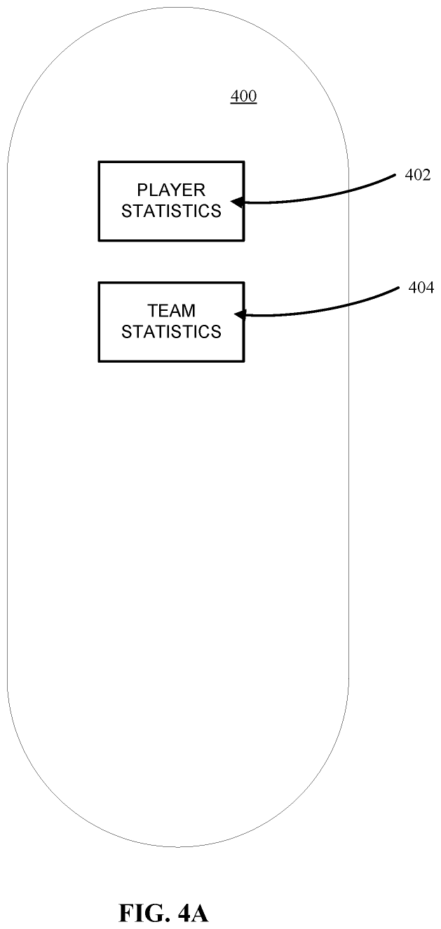

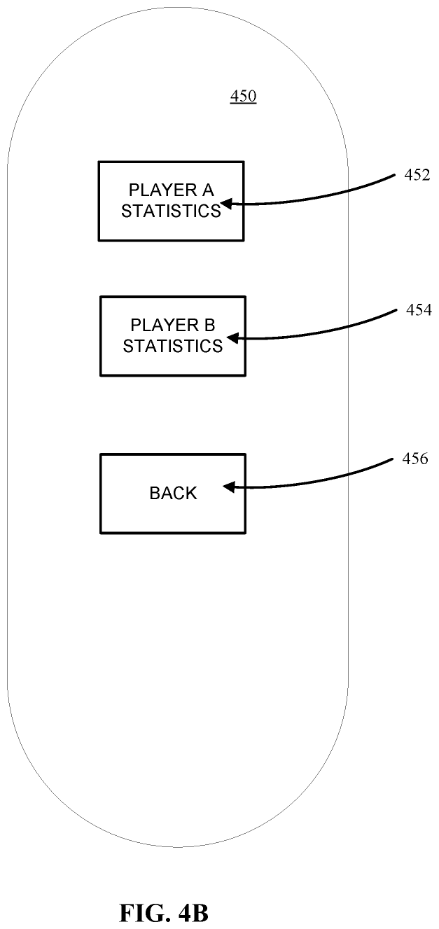

Turning to FIG. 4A, an example 400 of a user interface that can be presented on the remote control device are shown in accordance with some implementations of the disclosed subject matter. For example, in an instance in which the content item being presented is a sports game, the remote control device can present a group of selectable inputs (e.g., buttons 402 and 404) with labels, such as “player statistics,” “team statistics,” etc. Continuing further with this example, in some implementations, selection of a particular button can cause content corresponding to the selected button to be presented. Turning to FIG. 4B, an example 450 of a user interface that can be presented in response to a selectable input for “player statistics” is shown in accordance with some implementations of the disclosed subject matter. As illustrated in FIG. 4B, user interface 450 can include content items 452 and 454 corresponding to statistics for individual players. Continuing still further with this example, in some implementations, a user can then navigate back to the group of selectable inputs (e.g., to user interface 400 of FIG. 4A) using a back button 456. Note that the user interfaces shown in FIGS. 4A and 4B are merely exemplary and in some implementations, any suitable user interfaces that include any suitable content relevant to the content item being presented on the media device can be presented.

In some implementations, process 300 can cause the content to be presented on the display area of the remote control device using any suitable technique(s). For example, in some implementations, the remote control device can receive an indication of content to be presented from any suitable source.

As a more particular example, in some implementations, the media device can receive content to be presented on the remote control device from a server associated with the media content item being presented (e.g., a server that hosts the media content item, and/or any other suitable server), and the media device can transmit the content to the remote control device for presentation. In continuing this example, an application that is executing on the media device and that is associated with the presented media content item can receive content for presentation on the remote control device (e.g., in user interface 450). The media device can transmit the received content to the remote control device (e.g., over a Bluetooth Low Energy connection between the remote control device and the media device). In response, the remote control device can cause representations of the received content to be presented on the display area of the remote control device (e.g., content items 452 and 454 of user interface 450 in FIG. 4B).

As another more particular example, in some implementations, the remote control device can receive indications of content directly from a server associated with the media content item being presented (e.g., a server that hosts the media content item, and/or any other suitable server). Note that, in some implementations, indications of content to be presented on the remote control device can include any suitable information or instructions, such as instructions to present particular graphical content, instructions to present particular user interface controls for navigation, instructions to present text, images, or icons relating to particular supplemental content, and/or any other suitable information or instructions. For example, in response to a particular media content item being presented on the media device, the server associated with the media content item being presented can transmit the indications of content directly to the remote control device (e.g., over a wireless link between the server and the remote control device). In response, the remote control device can cause representations of the received content to be presented on the display area of the remote control device (e.g., content items 452 and 454 of user interface 450 of FIG. 4B).

Process 300 can then loop back to 312 and can continue presenting the content item on the media device. Process 300 can then proceed to 314 and can further update the content presented on the remote control device based on the content being presented on the media device. For example, in an instance in which a first actor was previously present in a first scene shown in the content item, the remote control device may have previously presented information about the first actor (e.g., biographical details related to the first actor, names of other television shows or movies the first actor has appeared in, and/or any other suitable information). Continuing with this example, in an instance in which the content item includes a second scene that includes a second actor, the remote control device can be updated to present information about the second actor (e.g., biographical details related to the second actor, names of other television shows or movies the second actor has appeared in, and/or any other suitable information). Note that, in some implementations, process 300 can cause content presented on the remote control device to be updated at any suitable time points and at any suitable frequency. For example, in some implementations, the remote control device can be pushed updates on content (e.g., from a server, from the media device, and/or from any other suitable source) at time points corresponding to a change in content of the media content item. As another example, in some implementations, the remote control device can be pushed updates on content (e.g., from a server, from the media device, and/or from any other suitable source) at any suitable regular frequency (e.g., once per minute, once per five minutes, and/or any other suitable frequency).

In situations in which the systems described herein collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personal information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Accordingly, systems, methods, and media for providing an enhanced remote are provided.

In some implementations, any suitable computer readable media can be used for storing instructions for performing the processes described herein. For example, in some implementations, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be understood that the above described steps of the processes described in connection with FIG. 3 can be executed or performed in any order or sequence not limited to the order and sequence shown and described in the figure. Also, some of the above steps of the process of FIG. 3 can be executed or performed substantially simultaneously where appropriate or in parallel to reduce latency and processing times.

It should also be noted that, as used herein, the term mechanism can encompass hardware, software, firmware, or any suitable combination thereof.

Although the invention has been described and illustrated in the foregoing illustrative implementations, it is understood that the present disclosure has been made only by way of example, and that numerous changes in the details of implementation of the invention can be made without departing from the spirit and scope of the invention, which is limited only by the claims that follow. Features of the disclosed implementations can be combined and rearranged in various ways.

1. A method for using enhanced remote controls, the method comprising:
detecting, at a remote control having a front surface and a rear surface, a fingerprint of a user using a fingerprint sensor on the remote control positioned in a region on the rear surface that corresponds with a placement of a finger of the user when holding the remote control;
identifying the user from a plurality of users based on the fingerprint;
authenticating, without user input, a user account corresponding to the identified user, wherein the user account is associated with a media content service that hosts and provides media content items to a media device paired with the remote control;
causing a plurality of indications of available media content items to be presented on the media device based on the authenticated user account;
receiving a selection of an indication of an available media content item via the remote control;
causing the selected media content item to begin being presented on the media device paired with the remote control; and
causing content related to the media content item to be presented on a display area of the remote control concurrently with presentation of the media content item on the media device.

2. The method of claim 1, further comprising automatically selecting a user profile from the user account that is associated with a plurality of user profiles based on the fingerprint.

3. The method of claim 1, further comprising concurrently with causing the plurality of indications of available media content items to be presented on the media device, causing first controls for navigating the plurality of indications to be presented on the display area of the remote control.

4. The method of claim 1, further comprising concurrently with causing the selected media content item to begin being presented on the media device paired with the remote control, causing second controls for manipulating playback of the selected media content item to be presented on the display area of the remote control.

5. The method of claim 1, wherein the plurality of indications of available media content items are personalized recommendations identified based on the authenticated user account.

6. The method of claim 1, wherein the plurality of indications are received from a server associated with the media content service that hosts and provides the media content items to the media device.

7. The method of claim 1, wherein the plurality of indications are received from the media device.

8. The method of claim 1, further comprising:
authenticating, without user input, a second user account corresponding to the identified user, wherein the second user account is associated with a second media content service that hosts and provides media content items to the media device paired with the remote control;
receiving, via the remote control, an input to switch to browsing media content items available via the second media content service; and
causing a second plurality of indications of media content items available via the second media content service to be presented on the media device based on the authenticated second user account.

9. The method of claim 1, further comprising measuring a physiological parameter of the user using a sensor of the remote control.

10. The method of claim 1, wherein the fingerprint sensor is located on a rear surface of the remote control and wherein the display area is located on a front surface of the remote control.

11. A remote control device that provides enhanced remote controls, the remote control device comprising:
a fingerprint sensor positioned in a region on a rear surface of the remote control that corresponds with a placement of a finger of a user when holding the remote control;
a display area; and
a hardware processor connected to the fingerprint sensor and the display area, wherein the hardware processor:
detects a fingerprint of the user using the fingerprint sensor on the remote control device;
identifies the user from a plurality of users based on the fingerprint;
authenticates, without user input, a user account corresponding to the identified user, wherein the user account is associated with a media content service that hosts and provides media content items to a media device paired with the remote control device;
causes a plurality of indications of available media content items to be presented on the media device based on the authenticated user account;
receives a selection of an indication of an available media content item via the remote control device;
causes the selected media content item to begin being presented on the media device paired with the remote control device; and
causes content related to the media content item to be presented on the display area of the remote control concurrently with presentation of the media content item on the media device.

12. The remote control device of claim 11, wherein the hardware processor is further configured to automatically select a user profile from the user account that is associated with a plurality of user profiles based on the fingerprint.

13. The remote control device of claim 11, wherein the hardware processor is further configured to, concurrently with causing the plurality of indications of available media content items to be presented on the media device, cause first controls for navigating the plurality of indications to be presented on the display area of the remote control.

14. The remote control device of claim 11, wherein the hardware processor is further configured to, concurrently with causing the selected media content item to begin being presented on the media device paired with the remote control, cause second controls for manipulating playback of the selected media content item to be presented on the display area of the remote control.

15. The remote control device of claim 11, wherein the plurality of indications of available media content items are personalized recommendations identified based on the authenticated user account.

16. The remote control device of claim 11, wherein the plurality of indications are received from a server associated with the media content service that hosts and provides the media content items to the media device.

17. The remote control device of claim 11, wherein the plurality of indications are received from the media device.

18. The remote control device of claim 11, wherein the hardware processor is further configured to:
authenticate, without user input, a second user account corresponding to the identified user, wherein the second user account is associated with a second media content service that hosts and provides media content items to the media device paired with the remote control device;
receive an input to switch to browsing media content items available via the second media content service; and
cause a second plurality of indications of media content items available via the second media content service to be presented on the media device based on the authenticated second user account.

19. The remote control device of claim 11, wherein the hardware processor is further configured to measure a physiological parameter of the user using a sensor of the remote control device.

20. The remote control device of claim 11, wherein the fingerprint sensor is located on a rear surface of the remote control device and wherein the display area is located on a front surface of the remote control device.

21. A non-transitory computer-readable medium containing computer executable instructions that, when executed, cause a hardware processor to provide enhanced remote controls, the method comprising:
detecting, at a remote control having a front surface and a rear surface, a fingerprint of a user using a fingerprint sensor on the remote control positioned in a region on the rear surface that corresponds with a placement of a finger of the user when holding the remote control;
identifying the user from a plurality of users based on the fingerprint;
authenticating, without user input, a user account corresponding to the identified user, wherein the user account is associated with a media content service that hosts and provides media content items to a media device paired with the remote control;
causing a plurality of indications of available media content items to be presented on the media device based on the authenticated user account;
receiving a selection of an indication of an available media content item via the remote control;
causing the selected media content item to begin being presented on the media device paired with the remote control; and
causing content related to the media content item to be presented on a display area of the remote control concurrently with presentation of the media content item on the media device.
